(19) United States
(12) Patent Application Publication
(10) Pub. No.: US 2006/0039301 A1
(43) Pub. Date: Feb. 23, 2006

(54) Node apparatus and RPR network

(76) Inventors: Takehito Tsuji, Kawasaki (JP); Shigehiro Haginaka, Kawasaki (JP)

Correspondence Address: KATTEN MUCHIN ROSENMAN LLP, 575 MADISON AVENUE, NEW YORK, NY, 10022-2585, US

(21) Appl. No.: 11/265,855

(22) Filed: Nov. 3, 2005

Related U.S. Application Data
(63) Continuation of application No. PCT/JP03/06910, filed on Jun. 2, 2003.

(51) Int. Cl. H04L 12/28

(52) U.S. Cl. 370/258

(57) ABSTRACT

The present invention provides a node apparatus constituting a network duplicated by a system 0 ring and a system 1 ring. The node apparatus includes: a normal mode processing section for transmitting, in the normal operation mode, a packets to an other node apparatus to a packet transmission ring which is either the system 0 ring or the system 1 ring; a center node processing section for determining, when a node functions as a center node receiving the largest volume of packets, the node as a target node based on a volume of packets from slave nodes, which are other nodes, to the node with the packet transmission ring for the packet to the center node in the normal operation mode to be changed and transmitting a target command for instructing the target node to change the packet transmission ring; and a target node processing section for changing, when the target command transmitted from the center node is received, the packet transmission ring for the packet to the center node having transmitted the target command.

This is a continuation of PCT International Application NO. PCT/JP03/06910, filed Jun. 2, 2003, which was not published in English.

### BACKGROUND OF THE INVENTION

1. Field of the Invention

The present invention relates to an IP MAN-based RPR network in which RPR nodes are linked in the ring type form with optical fiber lines installed along railways and roads.

2. Description of the Related Art

A ring network based on optical fiber lines is widely used for transmission of a large volume of data such as image data because of the economical efficiency and high reliability. The RPR (Resilient Packet Ring) is now being incorporated into the IEEE 802.17 standard as an L2 network protocol for a ring type IP packet. A packet transmission node determines which of the system 0 and system 1 is the shortest route to a receiving node according to the topology map, and transmits a packet according to a result of determination. Routing to the shortest route does not change dynamically unless there occurs such an event as generation of a trouble, degradation in signal transaction quality, or an intervention by an operator. Therefore, when viewed from a receiving node, packets from a node are always received through the system 0 or system 1.

FIG. 25 is a view showing an RPR network. As shown in FIG. 25, the ring network includes nodes 2#1 to 2#5 and a transmission channel. The RPR network is an optical duplicated ring network. This network includes two rings of a system 0 ring 4#0 and a system 1 ring 4#1. Operations of each of the nodes 2#i are as described below. Herein the node 2#1 is described. The node 2#1 exchanges topological information with other nodes 2#2, . . . 2#5, and detects the shortest route to each of the nodes 2#2, . . . 2#5 by measuring the number of hops to each of the nodes 2#2, . . . 2#5 or other parameters with respect to the system 0 ring 4#0 and system 1 ring 4#1.

When the node 2#1 receives a coded packet of a video signal picked up with a video camera or the like from an encoder or the like, the node 2#1 sends the coded packet to a packet transmission ring in the system 0 ring 4#0 or system 1 ring 4#1 providing the shortest route to a node (a receiving node) accommodating a server which is a destination for the transmitted coded packet. For instance, the node 2#1 sends a packet for the node 2#3 to the system 1 ring 4#1 as indicated by the arrow in FIG. 25. The node 2#4 sends a packet for the node 2#3 to the system 0 ring 4#0 as indicated by the arrow in FIG. 25. On the other hand, when the node 2#1 receives a packet from the system 0 ring 4#0 or system 1 ring 4#1, if the packet is not for the node 2#1, the node 2#1 transmits the packet to the system 0 ring 4#0 or system 1 ring 4#1 from which the packet was received.

A ring network has the feature that a node transmitting a packet (transmitting node) can select, to transmit data over the shortest route, to which of the system 0 ring 4#0 and system 1 ring 4#1 the data is to be transmitted in consideration to the positional relation with the receiving node. In the discussion stage for the RPR, also a scheme has been proposed in which a transmission line is decided not only depending on the number of nodes, but also on the cost and link rate (physical).

In a centralized network in which a center node is provided on an RPR network and packets from each transmitting node are managed in a concentrated manner, data traffics concentrate on one node.

FIG. 26 is a view showing the centralized network. In this case, the node 2#5 functions as a center node. Referring to the transmitting nodes 2#1 to 2#4 starting from the center node 2#5, it is understood that the ring network is branched to system 0 and system 1 and data is concentrated to the center node 2#5 through the system 0 or system 1. Further the ring network may be regarded as a two-branch tree in which each branch includes the same number of nodes. For instance, as shown in FIG. 26, packets from the nodes 2#2 and 2#1 are transmitted through the system 0 ring 4#0 and those from the nodes 2#3 and 2#4 are transmitted through the system 1 ring 4#1.

FIG. 27 is a view showing a two-branch tree. The centralized network shown in FIG. 26 can be shown as a two-branch tree as shown in FIG. 27. In this two-branch tree, a node on the downstream side is at a high level (close to the route level) because the node not only transmits, in addition to packets received by the node, those received from nodes on the upstream side to a transmission line. For instance, the center node 2#5 is at level 0, nodes 2#1 and 2#4 at level 1, and nodes 2#2 and 2#3 at level 2. Assume herein that a traffic rate through the system 1 ring 4#1 is substantially high and that through the system 0 ring 4#0 is low. Namely assume, for instance, that, in the system 1 ring 4#1, a traffic rate through the node 2#3 is 70 Mbps and that through the node 2#4 is 30 Mbps, and also that, in the ring 4#0, a traffic rate through the node 2#2 is 20 Mbps and that through the node 2#1 is 10 Mbps. In this case, a traffic rate of data flowing from the node 2#4 to the center node 2#5 is 100 Mbps.

In the RPR, for instance, when the node 2#4 tries to send a packet to the system 1 ring 4#1 and determines that the band thereof is not sufficient for transmission of the packet therefrom, the node 2#4 notifies the system 1 ring 4#1 which flows in the opposite direction to the system 0 ring 4#0, namely, in the upstream direction, of the situation of congestion and demands suppression of data traffics. As a result, the node 2#3 on the upstream side suppresses transmission of packets to the system 1 ring 4#1 to some extent, so that transmission of packets from the node 2#4 is enabled. Next assume that congestion in the system 1 ring 4#1 is detected and there is a sufficient allowance in a band of the system 0 ring 4#0. In this case, notification of congestion is not necessary. As described above, in the conventional technology, when congestion occurs in one system, the congestion is always notified to nodes on the upstream side, so that a traffic rate on the upstream side is disadvantageously suppressed even when notification of congestion is not necessary.

Japanese Patent Laid-Open No. 2001-45036 discloses that, when congestion occurs in an interactive ring network, an output bandwidth for nodes on the downstream side including the node in which the congestion has occurred is controlled for overcoming the congestion. In Japanese Patent Laid-Open No. 2001-45036, however, an output bandwidth of a node is controlled, and a packet transmission ring is not switched. Therefore even when it is required only to switch a packet transmission ring and restriction of the output band is not required, the output band is restricted, so that sometimes abortion of packets is required.

### SUMMARY OF THE INVENTION

An object of the present invention is to provide a node apparatus and an RPR network capable of transmitting data, even when congestion is detected, without notifying occurrence of congestion if the notification of the congestion is unnecessary.

In accordance with an aspect of the present invention, there is provided a node apparatus constituting a network duplicated by a system 0 ring and a system 1 ring, and this node apparatus includes a normal mode processing section for transmitting, in the normal operation mode, a packet to an other node apparatus to a packet transmitting ring which is either the system 0 ring or system 1 ring; a center node processing section for determining, when a node functions as a center node receiving the largest volume of packets, a node as a target node, which is a node with the packet transmission ring for the packet to said center node in the normal operation mode to be changed, based on a volume of packets from slave nodes, which are other nodes, and transmitting a target command for instructing the target mode to change the packet transmitting ring; and a target node processing section for changing, when the target command transmitted from the center node is received, the packet transmitting ring for the packet for the center node having transmitted the target command and shifting to dynamic band changing mode.

The node apparatus according to an embodiment of the present invention preferably includes a packet volume detecting section for detecting a volume of received packets to the node within a prespecified period of time; a received packet volume notifying section for notifying the volume of received packets to all of the other nodes; a received packet volume reception section for receiving the volume of received packets from other nodes; and a center node determining section for comparing the volume of received packets detected by the received packet volume detecting section to the received packets received by the received packet volume receiving section, and notifying, when it is determined that the node is a center node at the same time when the network is of a centralized type, that the node is a center node to all of other nodes.

The above and other objects, features and advantages of the present invention and the manner of realizing them will become more apparent, and the invention itself will best be understood from a study of the following description and appended claims with reference to the attached drawings showing some preferred embodiments of the present invention.

### BRIEF DESCRIPTION OF THE DRAWINGS

FIG. 1 is a view showing principles of the present invention;

FIG. 2 is a block diagram showing a node apparatus according to an embodiment of the present invention;

FIG. 3 is a block diagram showing a processing section in FIG. 2;

FIG. 4 is a flow chart illustrating operations for changing an operating mode;

FIG. 5 is a flow chart illustrating operations for determining a center node;

FIG. 6 is a flow chart illustrating the center node processing;

FIG. 7 is a flow chart illustrating operations executed by a target node determining processing section in a center node;

FIG. 8 is a flow chart illustrating operation executed by a target node processing section in the center node;

FIG. 9 is a flow chart illustrating operations executed by the target node processing section in a target node;

FIG. 10 is a flow chart showing operations executed by the target node processing section;

FIG. 11 is a flow chart illustrating operations executed by a normal operation switching-back section;

FIG. 12 is a flow chart illustrating operations executed by a normal operation switching-back section;

FIG. 13 is a flow chart illustrating operations executed by a normal operation switching-back section;

FIG. 14 is a flow chart illustrating operations executed by a normal operation switching-back section;

FIG. 15 is a view showing a node of an RPR mode and transition of operating state therein;

FIG. 16 is a view showing a format of a control packet;

FIG. 17 is a view showing types of control packets;

FIG. 18 is a view showing contents of a payload;

FIG. 19 is an RPR network according to an embodiment of the present invention;

FIG. 20 is a view showing the number of packets received by each node;

FIG. 21 is a view showing a flow of a packet for the center node;

FIG. 22 is a view showing a two-branch tree in which congestion has occurred;

FIG. 23 is a view showing the two-branch tree after the congestion processing;

FIG. 24 is a view showing a flow of a packet for the center node after the congestion processing;

FIG. 25 is a view showing an RPR network;

FIG. 26 is a view showing traffic in a centralized network; and

FIG. 27 is a view showing a two-branch tree.

### DETAILED DESCRIPTION OF THE PREFERRED EMBODIMENTS

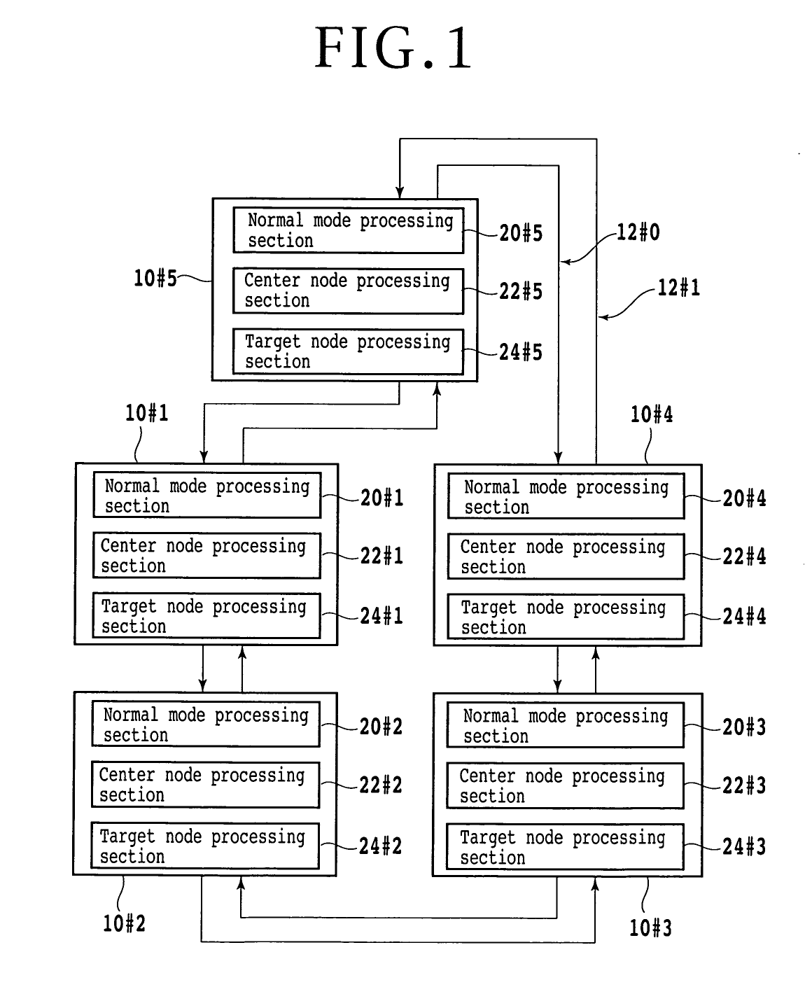

Principles of the present invention are at first described prior to description of embodiments of the present invention. FIG. 1 is a view illustrating principles of the present invention. As shown in FIG. 1, a duplicated ring network is formed with a plurality of nodes 10#1 to 10#5 as well as a system 0 ring 12#0 and a system 1 ring 12#1. Each node 10#i includes a normal mode processing section 20#i, a center node processing section 22#i, and a target node processing section 24#i. Operations of the node 10#5 are described assuming a case in which the node 10#5 is a center node receiving the largest volume (for instance, the number of received packets, a sum of packet lengths of the received packets) of packets for the node.

The normal mode processing section 20#i in each node 10#i transmits, when in the normal mode, packets for other nodes to any packet transmitting ring in either the system 0 ring 12#0 or system 1 ring 12#1. For packets to the center node 10#5, a transmitting ring for the nodes 10#1 and 10#2 is the system 0 ring 14#0, and a transmitting ring for the nodes 10#3 and 10#4 is the system 1 ring 14#1.

The center node processing section 22#5 in the center node 10#5 determines, as a target node, a node changing a packet transmitting ring for a packet to the center node 10#5 based on a volume of packets to the node 10#5 from slave nodes which are other nodes 10#1 to 10#4. Assume herein, for instance, that volumes of packets to the center node 10#5 via the nodes 10#1, 10#2, 10#3 and 10#4 are 10, 20, 70 and 30 respectively. In this case, the center node processing section 22#5 determines that the system 0 ring 12#0 has more space in band for data transmission as compared to the system 1 ring 12#1, and determines the node 10#4 changing the transmitting ring for packets to the center node 10#4 from the system 1 ring 12#1 to system 0 ring 12#0 as a target node.

The center node processing section 22#5 transmits a target command for instructing change of a packet transmitting ring to the target node 10#4. When the target node processing section 24#4 in the target node 10#4 receives the target command transmitted from the center node 10#5, the target node processing section 24#4 changes the packet transmitting ring for packets to the center node 10#5 having transmitted the target command from the system 1 ring 12#1 to system 0 ring 12#0. With this operation, in the target node 10#4, the packet transmitting ring is changed to the system 0 ring 12#1 having a larger space for data traffics for transmission of packets, and therefore it is not necessary to abort packets in nodes 10#3, 10#4 and others, which enables effective use of transmission bands.

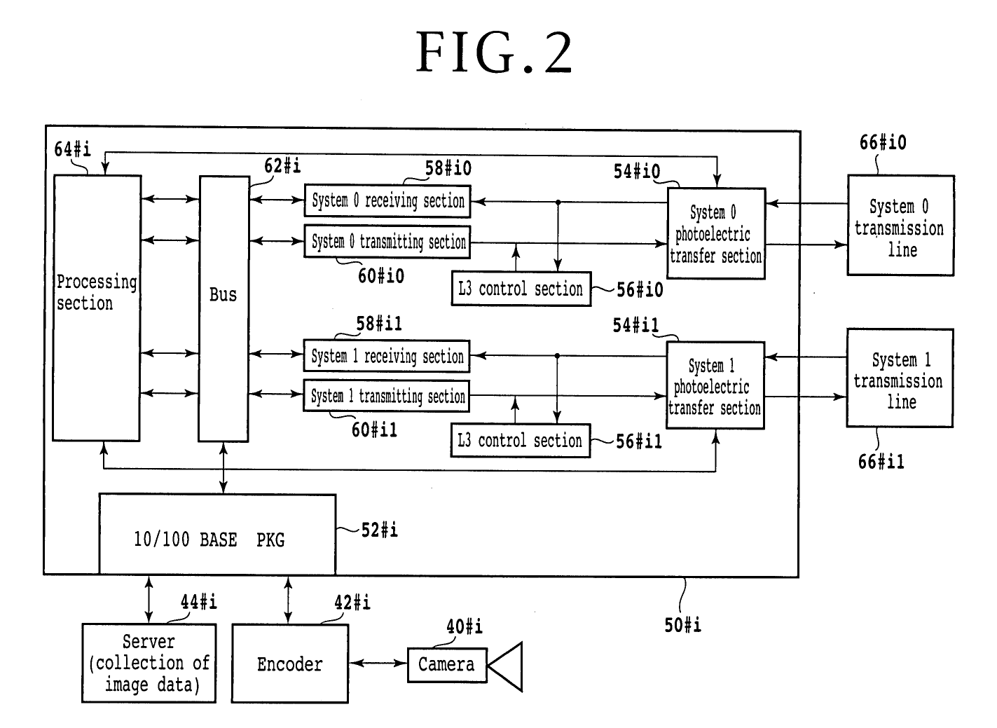

FIG. 2 is a block diagram showing an RPR node 50#i according to an embodiment of the present invention. As shown in FIG. 2, the RPR node #50i includes 10/100 BASE PKG 52#i, a system 0 photoelectric transfer section 54#i0, a system 1 photoelectric transfer section 54#i1, L3 controlling sections 56#i0, 56#i1, a system 0 receiving section 58#i0, a system 1 receiving section 58#i1, a system 0 transmitting section 60#0, a system 1 transmitting section 60#1, a bus 62#i, and a processing section 64#i.

The 10/100 BASE PKG 52#i functions as an interface for a 10/100 base with an encoder 42#1 or a server 44#i for collecting image data. Namely, the 10/100 BASE PKG 52#i receives a coded packet from the encoder 42#i and outputs the packet via the bus 62#i to the processing section 64#i. Further the 10/100 BASE PKG 52#i receives a coded packet to the server 44#i from the bus 62#i, and sends the coded packet to the server 44#i. The system 0 and 1 photoelectric transfer sections 54#i0, 54#i1 function as interfaces with the systems 0 and 1 transmission lines 66#0, 66#1 and the systems 0 and 1 transmission lines 60#i0, 60#i1 respectively. Namely the system 0 and 1 photoelectric transfer sections 54#i0, 54#i1 perform conversion between an optical signal and an electric signal.

The L3 controlling sections 56#i0, 56#i1 control packets, and more specifically have the following functions. The L3 controlling sections 56#i0, 56#i determine whether a control packet or an IP packet converted to an electric signal by the system 0 and 1 photoelectric transfer sections 54#i0, 54#i1 is sent to the node 50#i or a server 44#i accommodated in the node 50#i (described as a packet to the self node) or not. (i) When it is determined that the packet is one to the self node, the L3 controlling sections 56#i0, 56#i1 output, via the system 0 receiving section 58#i0, system 1 receiving section 58#i1, and bus 62#1, a control packet to a processing section 64#i and an IP packet to a 10/100 BASE PKG 52#i. (ii) When it is determined that the packet is not one to the self node, the L3 controlling sections 56#i0, 56#i1 output, via the system 0 receiving section 58#i0, system 1 receiving section 58#i1, bus 62#i, system 0 transmitting section 60#i0, and system 1 transmitting section 60#i1, the packet to the system 0 photoelectric transfer section 54#i0 and system 1 photoelectric transfer section 54#i1.

The system 0 receiving section 58#i0 and system 1 receiving section 58#i1 receive packets from the system 0 photoelectric transfer section 54#i0 and system 1 photoelectric transfer section 54#i1. The system 0 transmitting section 60#i0 and system 1 transmitting section 60#i1 receive control packets and IP packets from the processing section 64#i1 via the bus 62#1, and also receive other packets to be relayed to other nodes via the bus 62#i, and transmit the packets to the system 0 photoelectric transfer section 54#i0 and system 1 photoelectric transfer section 54#i1. The bus 62#1 is a bus for exchanging packets.

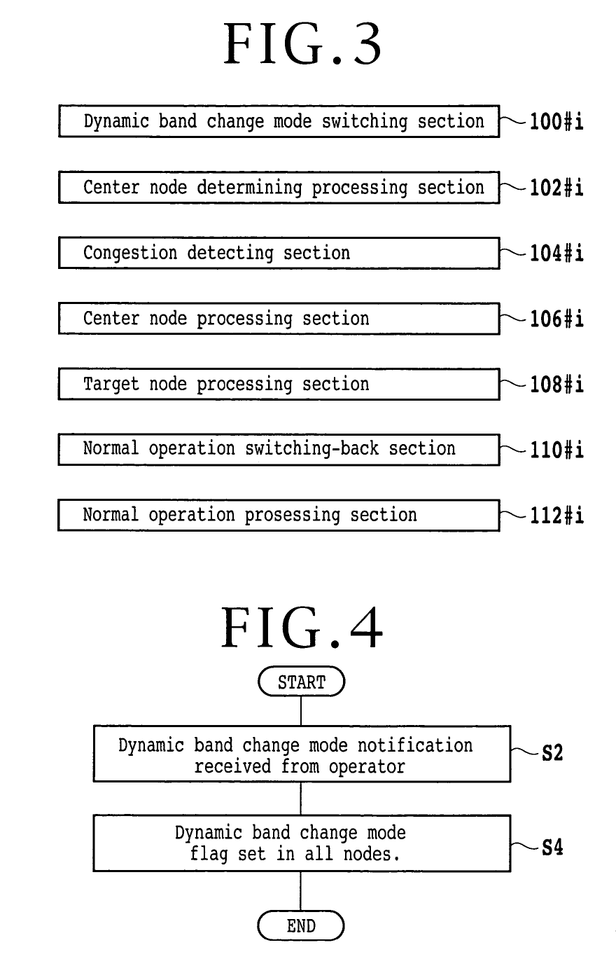

FIG. 3 is a block diagram showing the processing section 64#1 shown in FIG. 2. As shown in FIG. 3, the processing section 64#1 includes a dynamic band change mode switching section 100#i, a center node determining processing section 102#1, a congestion detecting section 104#i, a center node processing section 106#i, a target node processing section 108#i, a normal operation switching-back processing section 110#i, and a normal operation processing section 112#i.

FIG. 4 is an operation flow chart for the dynamic band change mode switching section 100#i. In step S2, an operator receives a packet for notifying the dynamic band change mode (packet A) transmitted from an NSP (Network Service Processor) to all nodes. In step S4, a dynamic band change mode flag is set for switching from the normal mode to the dynamic band change mode. In the normal mode, when congestion occurs, the congestion is removed by using the SRP fairness algorithm for the RPR ring, or the switching control is provided when any trouble occurs. In the dynamic band change mode, when congestion occurs, the congestion is removed without providing band control by sending a packet to a transmitting ring in the upstream direction.

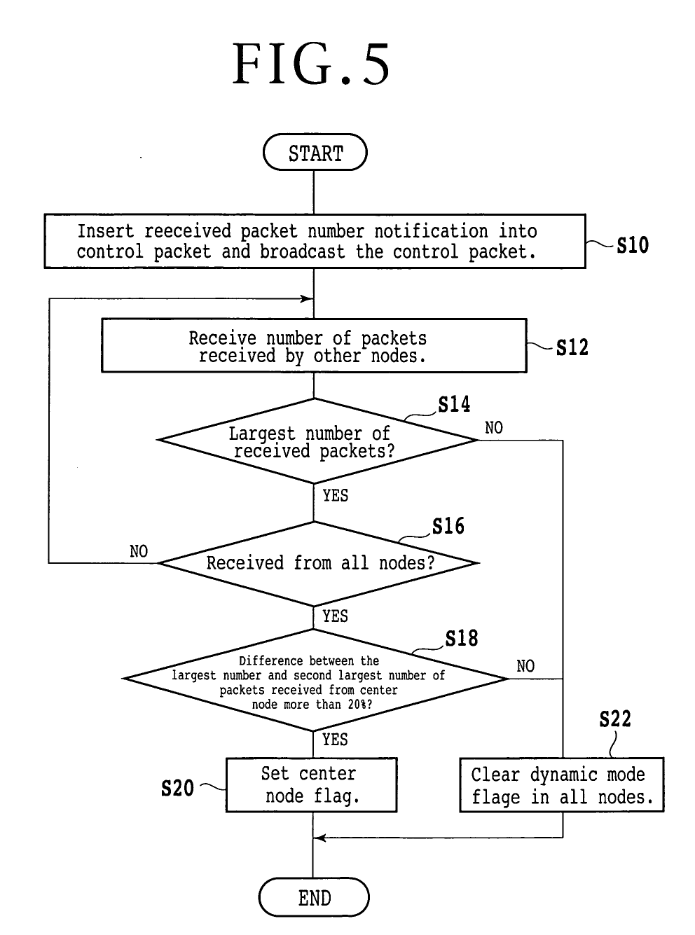

FIG. 5 is an operation flow chart for the center node determining processing section 102#i. In step S10, when the dynamic band change mode flag is set, “the number of received packets” within a prespecified period of time is counted, and a received packet number information notifying packet (packet C) including information concerning the number of received packets within the prespecified period of time is broadcasted. A received packet is a packet to the self node. In step S12, the center node determining processing section 102#i receives a packet C from other nodes. In step S14, the center node determining processing section 102#i determines whether the self node is a node receiving the maximum number of packets or not. When it is determined that the self node is a node receiving the maximum number of packets, the processing flows to step S16. When it is determined that the self node is not a node receiving the maximum number of packets, processing flows to step S22.

In step S16, the center node determining processing section 102#i determines whether the packets C have been received from all of the nodes or not. If there is any node from which the packet C has not been received yet, the processing flows back to step S12. When it is determined that the packets C have been received from all of the nodes, the processing flows to step S18. A node having received the maximum number of packets functions as a center node. In step S18, when a percentage of a difference between the maximum received packet number and second maximum received packet number against the maximum received packet number is within a prespecified range, the center node determining processing section 102#i determines whether the percentage is not less than 20% or not. When the percentage is not less than 20%, it can be considered that the network is a centralized one, the processing flows to step S20. When the percentage is not more than 20%, it is recognized that packets are transmitted substantially homogeneously. In this case, it is determined that the network is not a centralized one, and that the present invention can hardly be applied effectively, and the processing flows to step S22.

In step S20, the center node sets a center node flag. In step S22, the dynamic band mode flag is cleared. In step S22, the dynamic band change mode flag is cleared.

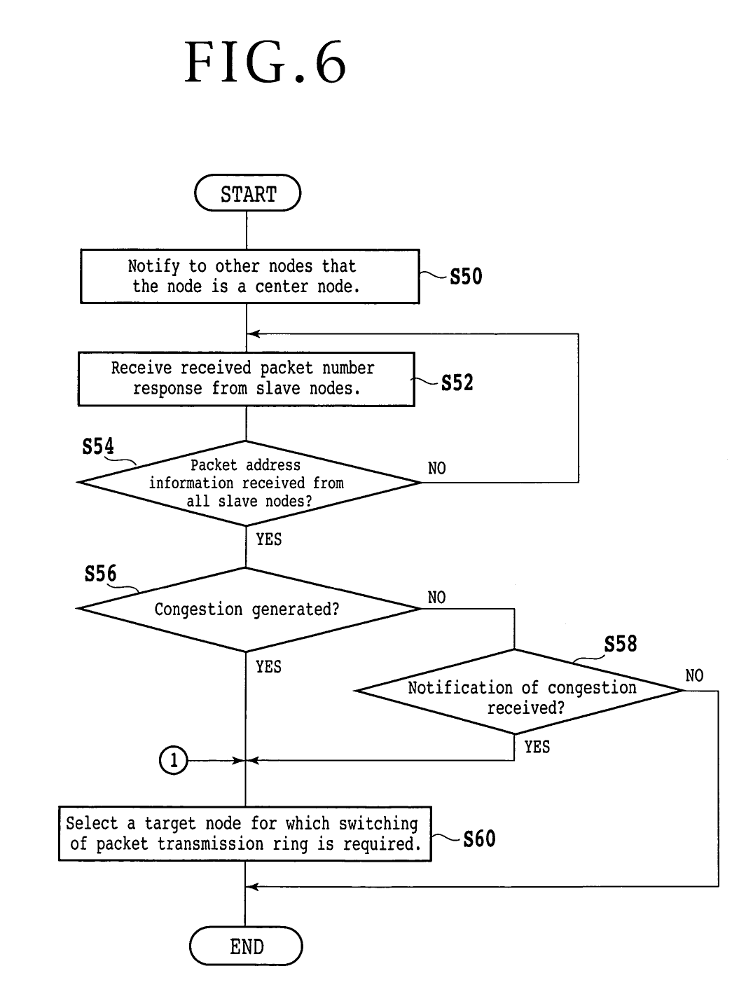

The congestion detecting section 104#i detects traffic on the transmitting side for the system 0 ring as well as for the system 1 ring. When the traffic is at a prespecified level or more and occurrence of congestion is detected, a node having detected congestion (congesting node) notifies all nodes of occurrence of congestion on the upload direction. FIG. 6 is an operation flow chart for the center node processing section 106#1. In step S50, when a node detects that the node is functioning as a center node, the node transmits a center node determination command (packet D) notifying that the node is a center node to all other nodes. When nodes other than the center node (slave nodes) receive a packet D, each of the nodes sends a received packet number response (packet E) including packet destination information indicating the number of packets to the center node.

In step S52, the packet E is received from the slave nodes. In step S54, the center node determining processing section 102#i determines whether the packet E has been received from all of the slave nodes or not. When it is determined that the packet E has been received from all of the slave nodes, the processing flows to step S56. When it is determined that the packet E has not been received from any of the slave nodes, the processing flows to step S52. In step S56, determination is made for whether congestion has occurred in the self node or not. When it is determined that congestion has occurred in the self node, the processing flows to step S60. When it is determined that congestion has not occurred, the processing flows to step S58. In step S58, determination is made for whether congestion has been notified from any other node or not. When it is determined that the notification has been received from any other node, the processing flows to step S60. When it is determined that the notification has not been received from any other node, the processing is terminated, because the dynamic band change is effective in the situation where congestion has occurred. In step S60, a target node to which switching of the packet transmitting ring is demanded is selected as described below. The target node as used herein indicates a slave node to which the center node instructs to “reverse ring selection” for transmission of a packet.

When a node functions as a center node, the node prepares a two-branch tree in the normal operation mode consisting of a system 0 and a system 1 based on the center node as a route and the number of hops in a system having a smaller number of hops from any other node to the center node as a level. Then the node buries outgoing packet addresses and the numbers of packets in the two-branch tree based on the numbers of received packets (responses). In this case, the total traffic rates to the center node through the system 0 and through the system 1 in the two-branch tree can be obtained, and thus a two-branch tree enabling division of the total traffic rate into two substantially equal portions can be decided according to the following topological considerations.

(a) The tree must be capable of evenly dividing a traffic rate into two substantially equal portions by changing a packet transmitting ring from the node to the center node.

(b) The number of hops from the center node switching a ring must be large. As a reverse ring is used for ring switching, the number of hops becomes smaller. With this functional configuration, data transmission can be performed with a small delay time to the center node.

(c) Although the algorithm is complicated to some extent, even if there are a plurality of target nodes in (a) and (b), a target node may be selected so that the number of target nodes to be ring-switched is minimized for reducing a work load in the processing.

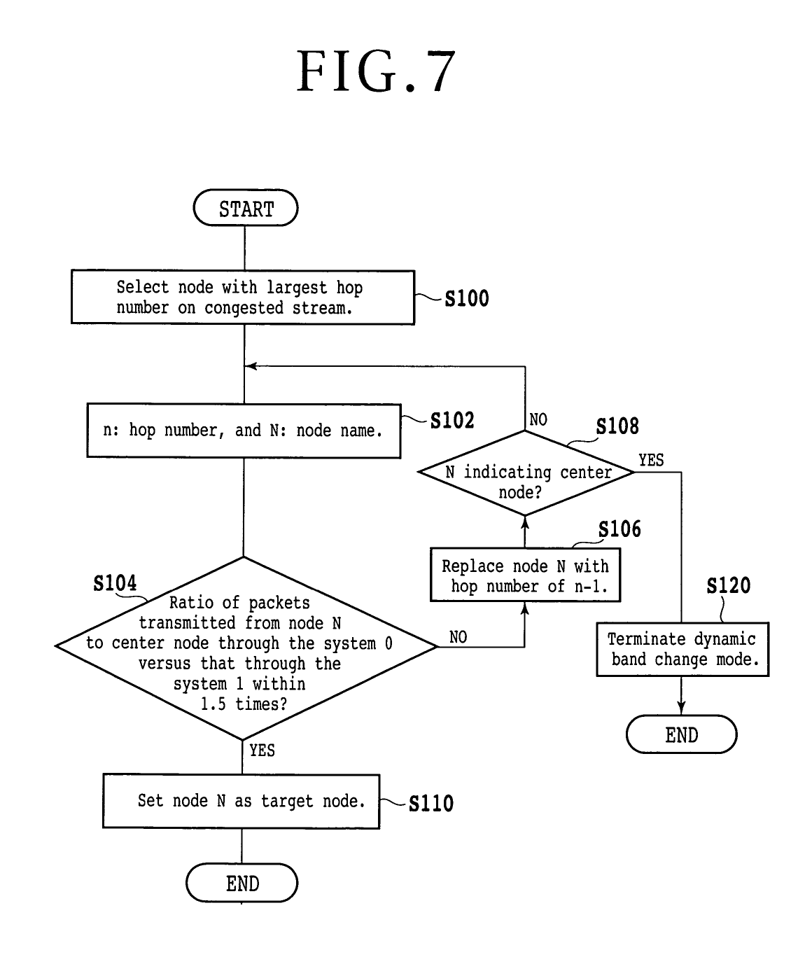

FIG. 7 is a flow chart illustrating an example of a method of a target node when only one target node is to be selected. In step S100, a node with the maximum number of hops is selected in the congested system 0 or system 1 (congested stream). The selection is made as described above, because the target node must satisfy the condition (b) above. In descriptions of step S102, n indicates the number of hops for the node, and N indicates the node name. In step S104, when a packet is sent from the node N to the center node through the reverse packet ring, determination is made for whether a ratio of packets to the center node from the system 0 or system 1 is within a prespecified range, for instance, within 1.5 times, because the condition (a) must be satisfied.

When the ratio is within a prespecified range, the processing flows to step S110. When the ratio is within a prespecified range, the processing flows to step S106. In step S106, the node N is switched to a node having the hop number (n-1). It is determined in step S108 whether N is a center node or not. When N is a center node, there is no target node satisfying the conditions (a) and (b), and therefore the processing flows to step S120. When N is not a center node, the processing returns to step S102. In step S110, N is set to a target node. In step S120, the dynamic band change mode is terminated.

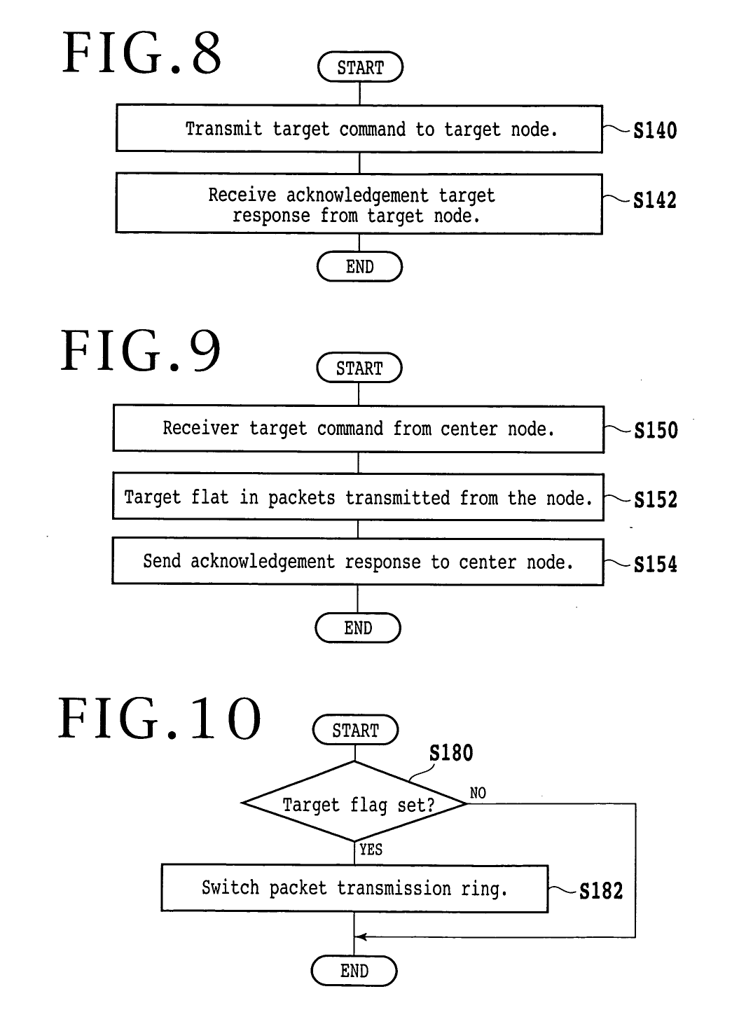

FIG. 8 is a flow chart illustrating operations of the target node processing 108#i in the center node. FIG. 9 and FIG. 10 are flow charts each illustrating operations of the target node processing 108#i in the target node. In step S140 shown in FIG. 8, when the node is a center node, a target command (packet F) indicating that the node has been specified as a target node (packet F) is transmitted. In step S150 shown in FIG. 9, the target node receives the packet F. In step S152, a target flag indicating the necessity of use of the reverse ring is shown for each of the packets transmitted from the node to the center node. With this operation, the packets to the center node each with the target flag set are transmitted through the reverse ring. In step S154 a target response indicating acknowledgement (packet G) is transmitted to the center node. In step S142 shown in FIG. 8, the packet G indicating acknowledgement is received from the target node.

FIG. 10 is a flow chart illustrating operations for controlling transmission of packets to the center node. In step S180, determination is made as to whether a target flag has been set or not. When it is determined that the target flag has been set, the processing flows to step S182. In step S182, a packet transmission ring for packets to the center node is switched. When it is determined that the target flag has not been set, the packets are transmitted without switching the packet transmission ring.

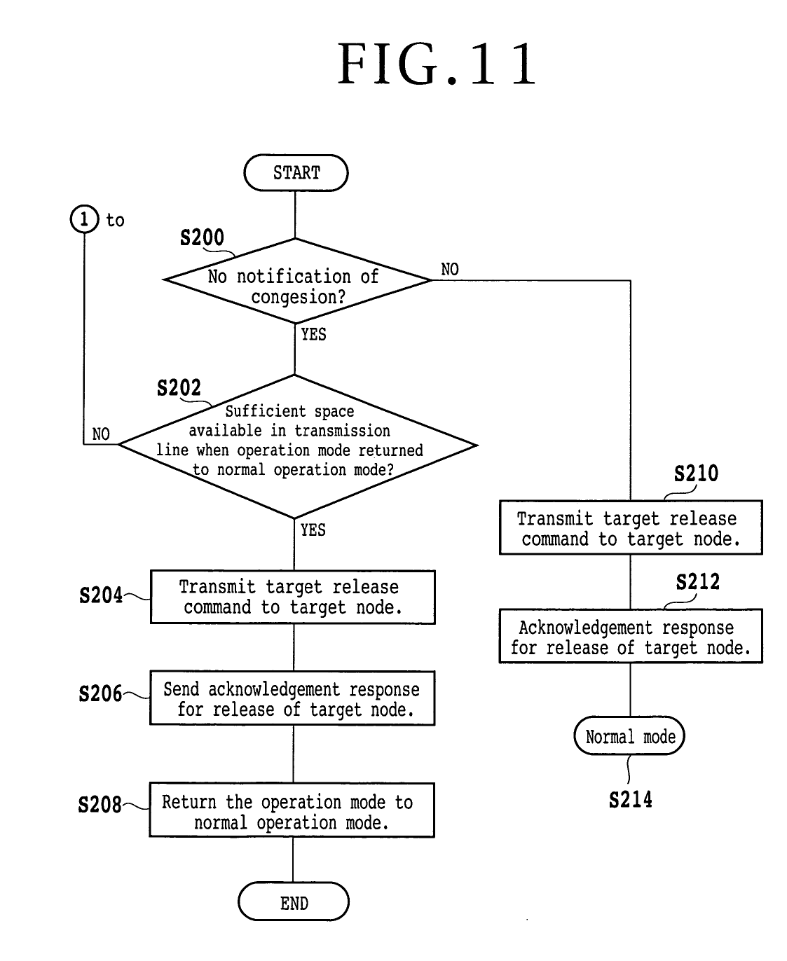

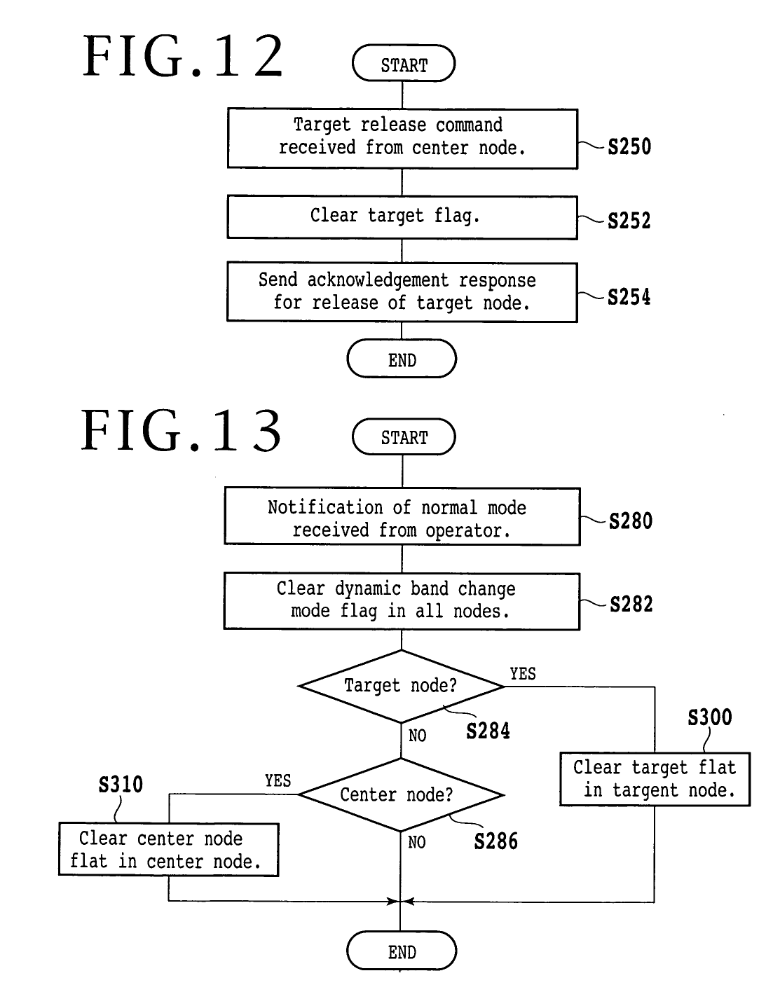

FIG. 11 and FIG. 12 are operation flow charts illustrating operations of a normal operation switching-back processing section 110#i. In step S200, whether notification of congestion has disappeared or not. When it is determined the notification of congestion has disappeared, the processing flows to step S202. When it is determined that the notification of congestion is still effective, the processing flows to step S210. In step S202, the center node periodically receives a received packet number response from each slave node, and determines whether a sufficient space can be acquired in a transmission line, when the operating mode is returned to the normal operation, or not. When it is determined that there is a sufficient space, the processing flows to step S204. When it is determined that there is not a sufficient space, the processing returns to step S60 shown in FIG. 6.

In step S204, a target release command (packet H) is transmitted to the target node, because the normal operation is more efficient from view points of communication cost and others when a sufficient space is available. In step S250 shown in FIG. 8, the target node receives the packet H. In step S252, the target flag is cleared. In step S254, an acknowledgement response (packet I) is transmitted to the center node. In step S206 shown in FIG. 7, the packet I is received. In step S208, the operating mode is returned to the normal operation mode.

In step S210, as congestion can not be overcome even by reversing the packet transmission ring for the target node, the packet H is transmitted to the target node. The target node executes the processing steps S250 to step S254 shown in FIG. 8. In step S212, the packet I is received. In step S214, the operating mode is returned to the normal operation mode.

FIG. 13 is a flow chart illustrating operations of the normal operation switching-back processing section 110#i when the operating mode is shifted from the dynamic band change mode to the normal operation mode according to an instruction from an operator. In step S280, normal mode notification (packet B) is received from the operator. In step S282, the dynamic band change mode flag is cleared in all of the nodes. In step S284, determination is made for whether the node is a target node or not. When it is determined that the node is not a target node, the processing flows to step S286. When it is determined that the node is a target node, the processing flows to step S300. In step S286, determination is made as to whether the node is a center node or not. When it is determined that the node is a center node, the processing flows to step S310. When it is determined that the node is not a center node, the processing is terminated. In step S300, the target flag is cleared in the target node. In step S310, the center node flag is cleared in the center node.

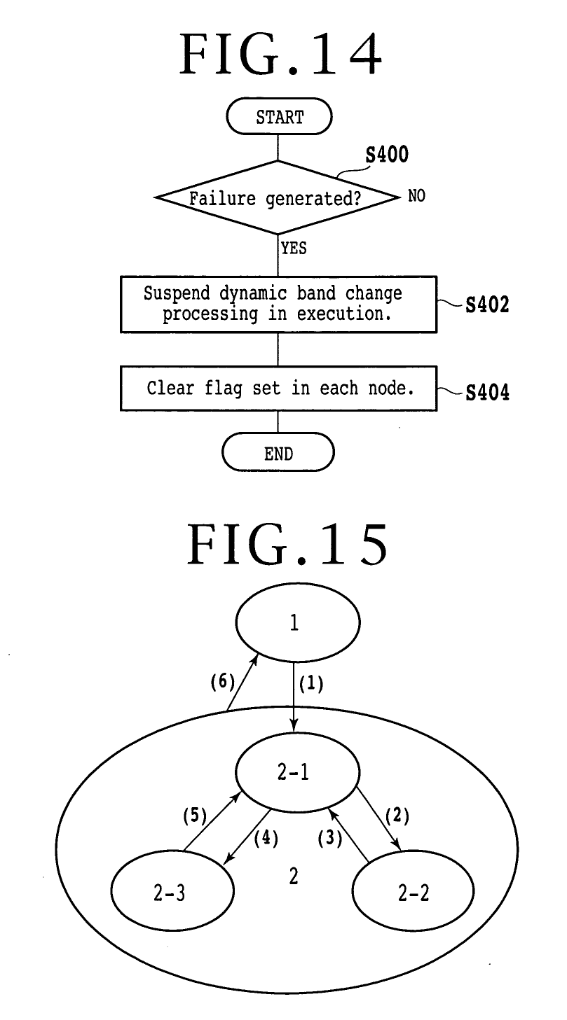

FIG. 14 is a flow chart illustrating operations executed when a failure occurs in the dynamic band change mode. In step S400, determination is made as to whether a failure has occurred or not. The failure as used herein indicates that in the system 0 ring or in the system 1 ring. When any failure occurs, the processing flows to step S400. When a failure does not occur, the processing is terminated. In step S402, the flag set in each node 50#i is cleared, because the processing in the dynamic band change mode can not be carried out when a failure occurs. With this functional configuration, a transmission line is switched when any failure occurs.

A normal operation processing section 112#i in FIG. 3 controls, according to such a parameter as the number of hops according to the network topology, transmission of packets to a packet transmission ring when any congestion is not present, eliminates congestion by using the SRP fairness algorithm for the RPR ring in the normal operation mode, and also controls ring switching when any failure occurs. FIG. 15 is a view showing an operating mode of the RPR node and transition of the processing state in the mode. As described above, the operating mode is classified into the normal mode 1 and the dynamic band change mode 2. When shifting to the dynamic band change mode 2, a center node determining processing 2-1, a center node processing 2-2, and a target node processing 2-3 are executed. In the normal mode 1, when the dynamic band change mode is notified in response to an intervention by an operator via the NMS as described in (1), the processing flows to the center node determining processing 2-1. In the center node determining processing 2-1, when the center node determination command is sent thereto, the processing flows to the center node processing 2-2. In the center node processing 2-2, when a target is determined as described in (4) above and a target command from the center node to the target node, the processing shifts to the target node processing 2-3. In the target node processing 2-3, as described in (5) above, when an acknowledgement response is issued to the center node, the operating mode shifts to the dynamic band change mode 2. On the other hand, in the dynamic band change mode 2, when a target release command is transmitted from the center node and the target node sends an acknowledgement response for releasing the target node to the center node, or when any failure occurs, the operating mode shifts to the normal mode 1 as described in (6).

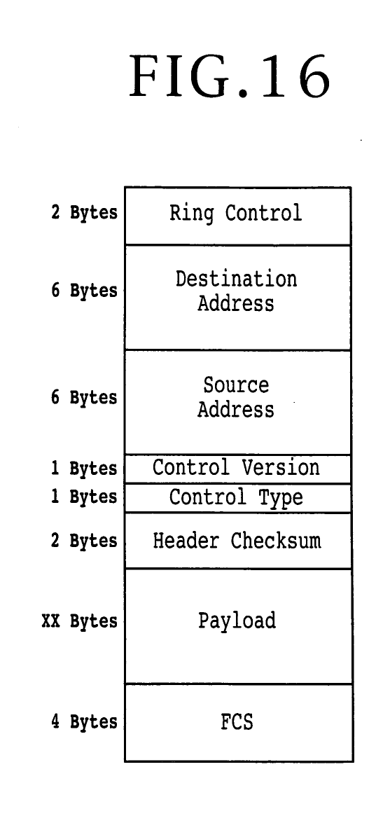

FIG. 16 is a view showing a format of a control packet. As shown in FIG. 12, a packet includes a ring control (2 bytes), a receiver (destination) address (6 bytes), a transmitter (source) address (6 bytes), a control version (1 byte), a control type (1 byte), a header check sum (2 bytes), a payload (variable-length byte), and an FCS. The ring control is a control signal such as priority, life and the like of the packet. The receiver address is an MAC address of a receiver node for the packet, and when a packet is broadcasted to all of other nodes, the broadcast address is all “F”. The transmitter address is an address of a node transmitting the packet. The control version is a version number of the packet format. As a control type, notification/command response type is set.

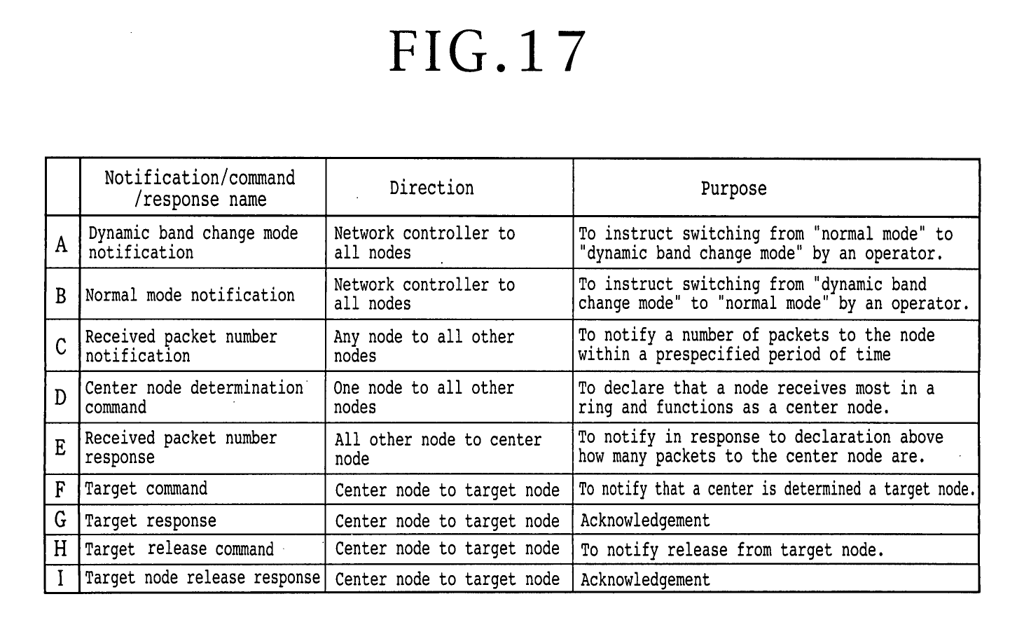

FIG. 17 is a view showing types of control packets each indicating a control packet type, a direction in which a control packet flows, and an application of the control packet. As shown in FIG. 17, the control packets include packets A to I for notification of the dynamic band change mode, notification of normal mode, notification of received packet number, center node determining command, a received packet number response, a target command, a target response, a target release command, and a target node release response.

The notification of dynamic band change mode is transmitted from the NMS to all nodes, and is used by an operator to instruct shift from the “normal mode” to the “dynamic band change mode”. The notification of normal mode is transmitted from the NMS to all nodes, and is used by an operator to instruct shift from the “dynamic band change mode” to the “normal mode”. The notification of the received packet number is transmitted from each node to all of other nodes and is used to notify the number of packets to the node counted within a prespecified period of time.

The center node determining command is transmitted from a node determined as a center node to all of other nodes, and is used by a node receiving packets most in the ring to declare that the node is a center node. The received packet number response is transmitted from all of other nodes to the center node, and is used to indicate how many packets to the center node there are. The target command is transmitted from the center node to the target node, and is used to notify that the node receiving the command has been determined as a target node. The target response is transmitted from the target node to the center node, and is used to notify acknowledgement of the target command. The target release command is transmitted from the center node to the target node, and is used to notify release from the target node. The target node release response is transmitted from the target node to the center node, and is used to notify acknowledgement of the target release command.

The header check sum shown in FIG. 12 is a check sum for a header. The payload is a data section in the packet. The following data is set in the payload according to a type of notification/command/response.

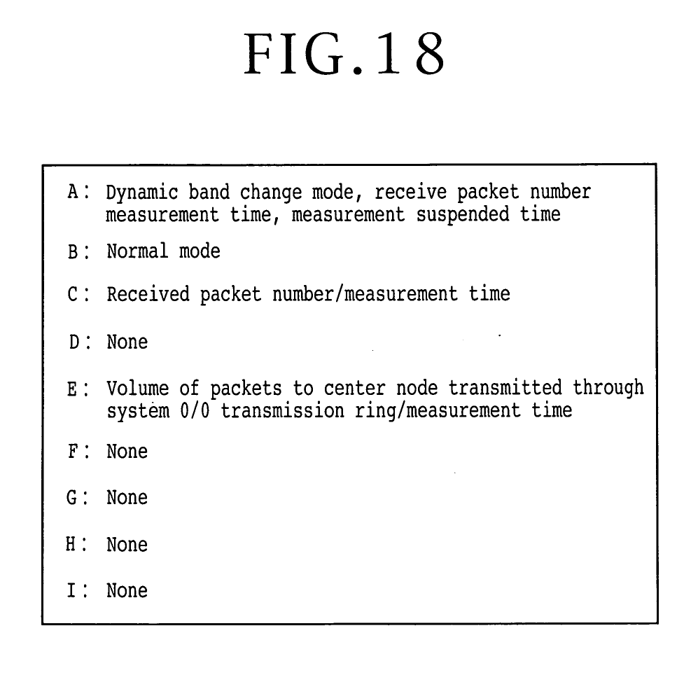

FIG. 18 is a view showing contents of a parameter set in the payload. As shown in FIG. 18, in a case of the packet A, the data indicating that the current operating mode is the dynamic band change mode, a period of time for measurement of the number of received packets, and a period of time in which measurement is suspended is set. In a packet B, data indicating that the current mode is the normal mode is set. In a packet C, data concerning the number of received packets and a period of time for measurement is set. No data is set in a packet D. In a packet E, data concerning a volume of packets sent to the center node and a type of a ring used for transmitting packets to the center node is set. No data is set in packets F, G, H, and I.

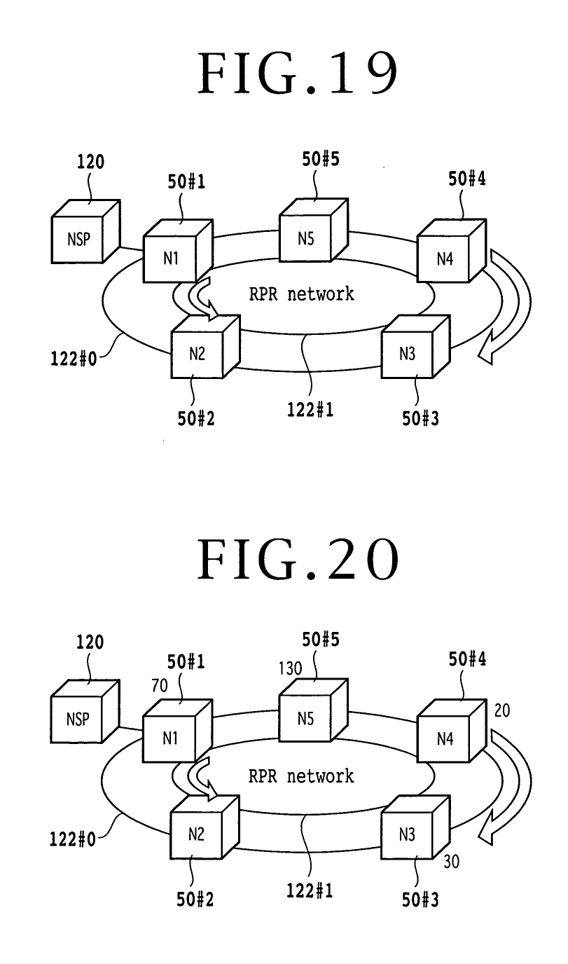

Descriptions are provided below for operations for dynamically changing a band. FIG. 19 is a view showing an example of configuration of the RPR network. This RPR network includes five nodes 50#i (i=1, 2, . . . 5), an NSP 120, a system 0 ring 122#0, and a system 1 ring 122#1. In the following descriptions of the RPR network, a case is assumed in which an image is picked up with a video camera 40#i installed at a station or the like, the image is converted by an encoder 42#i to a packet, and a node 50#i having received the packet sends the packet to a receiver node for the packet.

(1) Switching to the Dynamic Band Change Mode

In the RPR network, when the normal operation mode is effective, a transmission line for a packet is decided according to the routine in the normal operation mode, and the packet is transmitted through the transmission line as indicated by the arrow in the FIG. 19. When an operator consider that mode change is required, notification of dynamic band change mode (packet A) is broadcasted to all nodes via the NSP 152. The dynamic band change mode is notified, for instance, when image signals are concentrated to and controlled by the center node to monitor images send to a server connected to the center node from each node and the image quality is degraded. When each of the nodes 50#i (i=1, 2, . . . 5) receives a packet A, the dynamic band change mode flag is set.

(2) Center Node Determining Processing

When the dynamic band change mode flag is set, each of the nodes 50#i (i=1, 2, . . . 5) counts the number of packets received within a prespecified period of time. The number of packets received within the prespecified period of time is broadcasted with a packet C to all of the nodes. Each of the nodes 50#i (i=1, 2, . . . 5) receives the number of received packets with the packet C from all of other nodes. Each of the nodes 50#i compares the number of packets received by the node to those received by other nodes to determine whether or not the node is one receiving the most packets. A node having recognized that the node have received most packets determines that the node is a center node. Each of the nodes 50#i determines whether or not a percentage of a difference between the maximum number of received packets and the second maximum number of received packets against the maximum number of received packets is 20% or more and the RPR network is a centralized one. When it is determined that the RPR network is a centralized one, the processing is continued. When it is determined that the RPR network is not a centralized one, the node 50#1 clears the dynamic band change mode flag and sends packets selecting the transmission line according to the normal operation mode.

FIG. 20 is a view showing a number of packets received by each node. In the following descriptions, it is determined that numbers of packets received by the node 50#1, node 50#2, node 50#3, node 50#4, and node 50#5 are 70, 0, 30, 20, and 130 respectively. Because the maximum number of received packets is 130 received by the node 50#5, the second maximum number of received packets is 70 received by the node 50#1, and a percentage of a difference (60) between the maximum number of received packets and the second maximum number of received packet against the maximum number of received packets (130) is 46%, namely larger than 20%, and therefore it is determined that this network is a centralized one. The center node 50#5 notifies, to other nodes 50#1 to 50#4, with a packet D that the node 50#5 is a center node. When the nodes 50#1 to 50#4 receive the packet D, each of the nodes 50#1 to 50#4 periodically notifies the number of the packets to the center node 50#5 with the packet E.

(3) Detection of Congestion

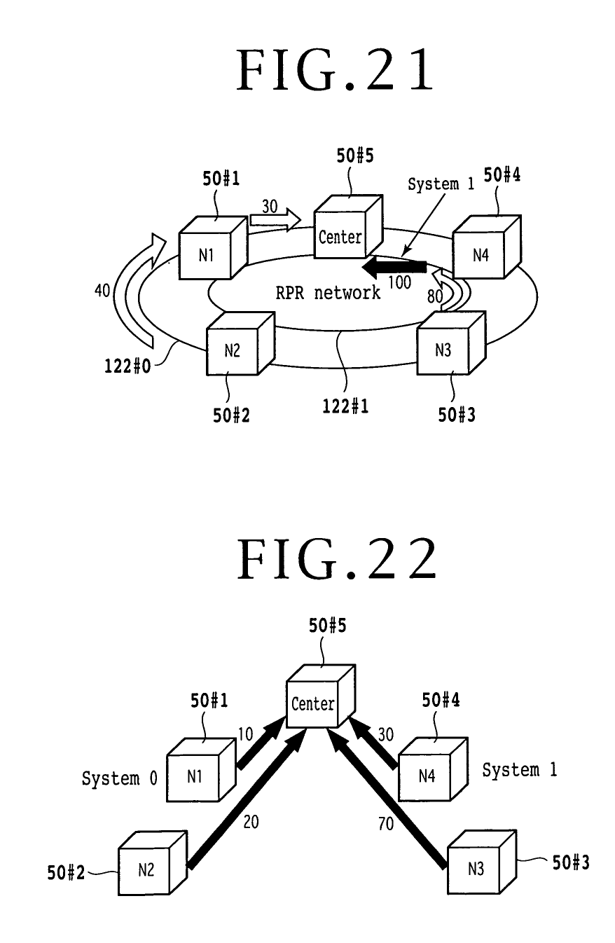

FIG. 21 is a view illustrating operations for detecting congestion. Each of the nodes 50#1 to 50#4 determines whether or not congestion occurs in the system 0 ring 122#0 or in the system 1 ring 122#1. In the following descriptions, it is assumed that the node 50#4 detects a traffic data in the transmission side of the system 1 ring 122#1 as 100 Mbps and recognizes occurrence of congestion. The congested node 50#4 transmits a congestion notifying packet to the center node 50#5 through the system 0 ring 122#0 in the upstream direction.

(4) Center Node Processing

The center node 50#5 periodically receives received packet response information, and when a congestion notifying packet is received, the center node 50#5 recognizes the number of packets transmitted from each of the slave nodes 50#1 to 50#4 to the center node 50#5 from the received packet response information.

FIG. 22 is a view showing a two-branch tree when congestion occurs. The center node 50#5 divides the nodes 50#1 to 50#4 to two groups allocated in the system 0 and system 1 and buries outgoing packet addresses and the number of packets transmitted from each node in the two-branch tree. Assuming that traffic rates from the nodes 50#1, 50#2, 50#3, and 50#4 to the center node 50#5 are 10 Mbps, 20 Mbps, 70 Mbps, and 30 Mbps respectively, a two-branch tree is formed in which, as shown in FIG. 22, the node 50#1 is at level 1 and node 50#2 is at level 2 in the system 0 and node 50#4 is at level 1 and the node 50#3 is at level 2. With this configuration, the total traffic rates of packets to the center node 50#5 in the system 0 and in the system 1 can be determined, and therefore a two-branch tree allowing for evenly dividing the traffic rate to two portions substantially equal to each other can be decided according to the procedure as described above.

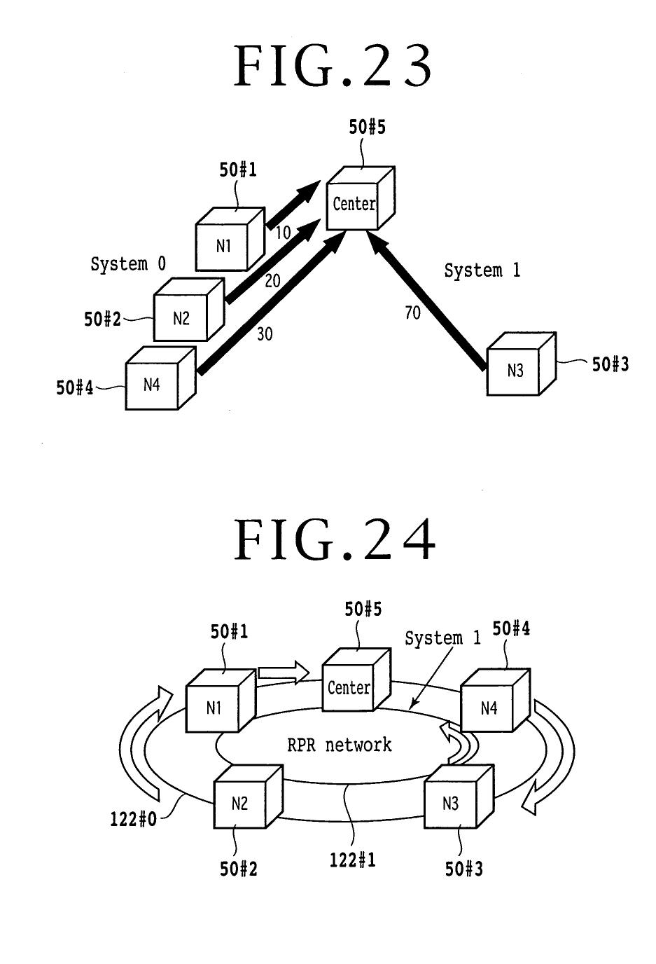

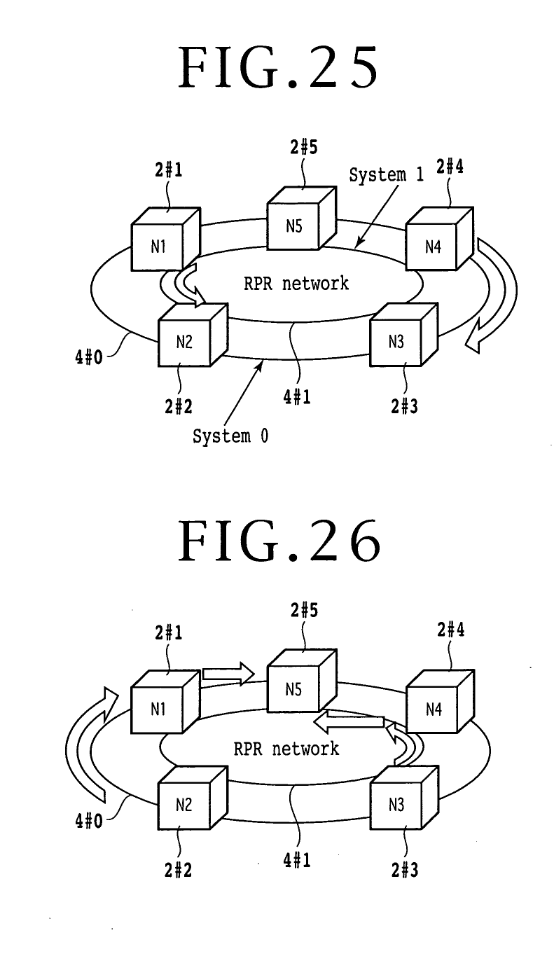

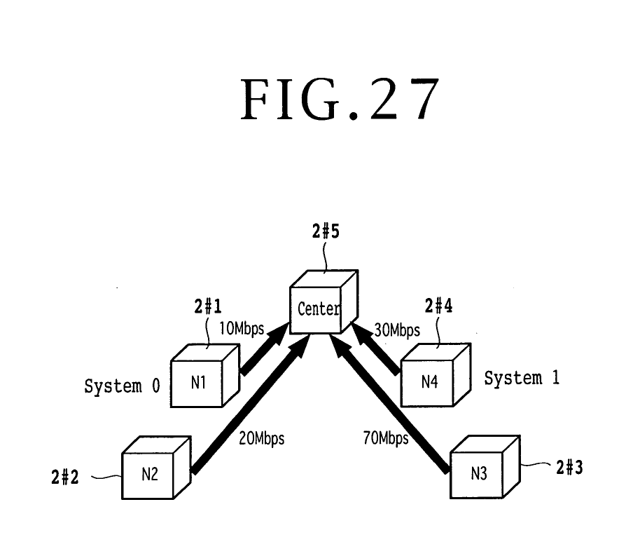

FIG. 23 is a view showing the two-branch tree after the congestion processing. The congestion storm is in the system 1 ring 122#1, so that, of the node 50#3 and node 50#4 each using the system 1 ring 122#1 as a transmitted packet ring respectively, the node 50#3 having the largest hop number is selected. When a packet is transmitted from the node 50#3 to the center node 50#5 through the system 0 ring 122#0, the center node receives 100 (10+20+70) packets from the system 0 and 30 packets from the system 1, and a ratio of the number of packets transmitted through the system 0 versus that transmitted through the system is not within 1.5 times, so that the node 50#4 having the second largest hop number is selected. Assuming that the packet transmission ring for the node 50#4 is system 0, the center node 50#5 receives 60 (10+20+30) packets from the system 0 and also receives 70 packets from the system 1, and the ratio of the number of packets received through the system 0 versus that received through the system is within 1.5 times, and therefore the node 50#4 is selected as a target node. With this operation, a two-branch tree is obtained in which the nodes 50#1, 50#2, and 50#4 are allocated to the system 0 and the node 50#3 is allocated to the system 1.

After the congestion processing, the transmission ring for the node 50#4 is changed, so that the center node 50#5 sends the packet F to the node 50#4. When the node 50#4 receives the packet F, the node 50#4 sends a response indicating acknowledgement with the packet G to the node 50#5.

(5) Target Node Processing

FIG. 24 is a view showing a flow of a packet to the center node after the congestion processing. A target node flag is set in the target node 50#4, and the target node 50#4 checks an destination address of each packet received from an encoder accommodated therein, changes a transmission ring for the packet to the center node 50#5 from the system 1 ring 122#1 to the system 0 ring 122#0, and sends the packet to the system 0 ring 122#0 as indicated by the arrow in FIG. 24. With this functional configuration, the node 50#4 can transmit a packet to the center node 50#5, without suppressing transmission of packets to the center node 50#5, by changing the packet transmission ring from the system 1 ring 122#1 to the system 0 122#0. Further, as shown in FIG. 24, the node 50#3 which is not a target node sends packets to the center node 50#5 through the system 1 ring 122#1, and also the nodes 50#1 and 50#2 which are not target nodes send packets to the center node 50#5 through the system 0 ring 122#0.

(6) Switching Back to Normal Operation

After the congestion processing, the center node 50#5 receives periodically receives a received packet number response each as a packet E, and checks whether a sufficient space can be acquired in the transmission line when the operation mode is returned to the normal operation mode. When it is determined that there is a sufficient space enabling the dynamic band change mode even when congestion occurs, the center node 50#5 returns the operation mode to the normal operation mode as described below. The center node 50#5 sends a target release command (packet H) to the node 50#4. The target node 50#4 clears the target flag when the node receives the packet H, and returns a response indicating acknowledgement of target node release (packet I) to the center node 50#5. Further the operation mode is switched back to the normal operation mode when any failure occurs in the transmission line. For instance, when a failure occurs in the system 0, the operation mode is switched back to the normal operation mode to switch the transmission ring to the system 1.

With the present invention described above, when congestion occurs in a node, a ring transmission system is switched without suppressing data traffic by aborting a portion of packets in the upstream side, so that occurrence of congestion can be prevented without suppressing data traffic, and an empty space can effectively be used.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A node apparatus constituting a network duplicated by a system 0 ring and a system 1 ring, said node apparatus comprising:
a normal mode processing section for transmitting, in the normal operation mode, a packet to an other node apparatus to a packet transmission ring which is either said system 0 ring or said system 1 ring;
a center node processing section for determining, when a node functions as a center node receiving the largest volume of packets, a node as a target node, which is a node with the packet transmission ring for the packet to said center node in the normal operation mode to be changed, based on a volume of packets from slave nodes, which are other nodes, and transmitting a target command for instructing the target node to change the packet transmission ring; and
a target node processing section for changing, when said target command transmitted from said center node is received, said packet transmission ring for the packet to the center node having transmitted said target command.

2. The node apparatus according to claim 1 further comprising:
a packet volume detecting section for detecting a volume of received packets to the node received within a prespecified period of time;
a received packet volume notifying section for notifying said volume of received packets to all of other nodes;
a received packet volume reception section for receiving said volume of received packets from the other nodes; and
a center node determining section for comparing the volume of received packets detected by said received packet volume detecting section to the volume of received packets received by said received packet volume reception section and notifying, when it is determined that the node is said center node and at the same time the network is of a centralized type, that the node is said center node to all other nodes.

3. The node apparatus according to claim 2,
wherein said center node determining section determines, when a percentage of a difference between the largest volume of received packets and the second largest volume of received packets against said largest volume of received packets is not less than a prespecified value, that said network is of the centralized type.

4. The node apparatus according to claim 1,
wherein said center node processing section does not send said target command when any congestion has not occurred in said system 0 ring nor in said system 1 ring, and sends said target command when occurrence of congestion is detected.

5. The node apparatus according to claim 1,
wherein said center node processing section decides said target node in each of said system 0 ring and system 1 ring based on a number of hops from said slave node to said center node in a packet transmission ring for said slave node in said normal operation mode as well as a number of packets sent from said slave node to said center node so that a traffic rate of packets to said center node is divided to two portions substantially equal to each other and sent through said system 0 ring and system 1 ring respectively.

6. The node apparatus according to claim 5,
wherein said center node processing section selects a node having larger number of hops in said normal operation mode preferentially as said target node.

7. The node apparatus according to claim 4 further comprising:
a normal operation switching-back section for transmitting, when the node is said center node, a target release command to said target node, and also for switching back, when said target release command is received from said center node, the packet transmission ring for packets to said center node to that used in said normal operation mode in accordance with elimination of said congestion.

8. The node apparatus according to claim 1,
wherein said center node processing section performs determination of said target node and notification to said target node based on dynamic band change mode notification from the outside.

9. The node apparatus according to claim 1,
wherein said normal operation switching-back section switches the operation mode to said normal operation mode when a failure occurs in said system 0 ring or in said system 1 ring.

10. An RPR network duplicated by system 0 ring and system 1 ring by system each including a plurality of node apparatuses and transmission lines, said RPR network comprising:
a normal mode processing section provided in each node apparatus for sending in the normal operation mode packets to each of other nodes to a packet transmission ring which is either said system 0 ring or system 1 ring;
a center node processing section provided in each of said node apparatuses for determining, when a node receives packets functions as a center node receiving the largest volume of packets, a node as a target node, which is a node with the packet transmission ring for the packet to said center node in the normal operation mode to be changed, based on a volume of packets from slave nodes, which are other nodes, and transmitting a target command for instructing the target node to change the packet transmission ring; and
a target node processing section provided in each node apparatus for changing, when said target command transmitted from said center node is received, said packet transmission ring for packets to the center node having transmitted said target command and transiting to dynamic band change mode.
